(19) United States
(12) Patent Application Publication
(10) Pub. No.: US 2008/0077452 A1
(43) Pub. Date: Mar. 27, 2008

(54) SUBSCRIPTION MANAGEMENT FOR PERIODIC TRAVEL SERVICES

(75) Inventors: Peter Dugan, Morristown, NJ (US); Peter Gallic, Chatham, NJ (US)

Correspondence Address: DARBY & DARBY P.C., P.O. BOX 770, Church Street Station, New York, NY, 10008-0770, US

(73) Assignee: Crystal International Travel Group, Inc., Chatham, NJ (US)

(21) Appl. No.: 11/467,517

(22) Filed: Aug. 25, 2006

(51) Int. Cl. G06Q 10/00

(52) U.S. Cl. 705/5

(57) ABSTRACT

Managing and distributing the right to obtain seats from a travel service vendor comprises contracting with the travel service vendor for a total number of seats at a bulk discount rate. A package is defined which includes the right to obtain a prescribed number of seats from the total number of seats in each of several intervals of time. A net present value of the package is computed. An offering amount for the package is defined at the net present value plus a transaction margin. A customer is subscribed to the offering. Any collected offering amounts are invested to generate a ticket payment for a seat claimed by the customer. The travel service vendor is then paid for a seat claimed by the customer using the ticket payment. Customers may also be periodically charged an activity margin. A spread may also be collected from the investment account.

### FIELD OF INVENTION

The present invention relates generally to a method for applying subscription dynamics to the management of periodic travel services, and more particularly to collecting margins on the marketing of a right to seats on a travel service that is realizable at one or more specified intervals.

### BACKGROUND OF THE INVENTION

There are millions of people who conduct regular, habitual travel that can be planned out over a very long time horizon, such as for up to 20 years or more. These “habitual” travelers may include owners of vacation time-share properties, e.g., vacation homeowners who require an air component in their travel mix. These “habitual” travelers may also include executives who participate in regularly scheduled meetings at business with far-flung locations.

These “habitual” travelers may travel to the same destination, for the same weeks, or over a period of time. These “habitual” travelers have attempted to manage the costs and enjoy discounts by 1) purchasing early at retail locations (e.g., APEX or advanced payment excursion fares), 2) purchasing multiple tickets at a time (e.g., discount books), or 3) leveraging bulk purchasing arrangements. Leveraging bulk purchasing arrangements may include buying via contract arrangements with travel agent networks or consortia. These contract arrangements may consist of having VTS, Carlson/Wagonlit, or another travel network provider offer such contracts within a particular place of business (i.e. captive provider).

In addition, sophisticated wholesalers such as tour operators and meetings or incentive companies make block “air transportation plan” arrangements with the airlines. The wholesalers commit to driving significant numbers of their clients to a specific airline for the right to receive a deep discount. The deep discount benefits the wholesalers' own margin along with being a good value to customers.

Finally, the online travel provision industry, which recently formed, evolved by 1) contracting with the airlines for deep discounts on remnant seat availability and 2) “meta-searching” other online providers or a Global Distribution System (GDS) such as Apollo or Galileo, to grab a seat. The online travel provision industry has also migrated towards securing forward contract rates to guarantee block seat availability.

In all of the above cases, the airlines operate at risk in the market since a price commitment for a future travel date may ultimately cost them more than the price they had agreed to in advance. In a business environment of cost volatility, the air travel industry is not thriving. Hence the airlines and other carriers need a new way to manage and grow profitably with less risk. Thus, it is with respect to these considerations and others that the present invention has been made.

### SUMMARY OF THE INVENTION

In accordance with one aspect of the invention, a method manages and distributes a right to obtain seats for travel on an airline. The method includes defining a package which includes the right to obtain a prescribed number of seats in each of several intervals of time, computing a net present value of the package, defining an offering amount for the package at the net present value plus a transaction margin, subscribing a customer to the offering, investing any collected offering amounts in an investment account, and paying the airline for any seats claimed by the customer using funds from at least the investment account. The step of subscribing the customer to the offering includes obtaining the customer's commitment to pay the offering amount, collecting at least a portion of the offering amount from the customer, and enabling the customer to claim the prescribed number of seats in at least one of the several intervals.

In accordance with another aspect of the invention, a method manages and distributes the right to obtain seats from a travel service vendor. This method comprises the steps of contracting with the travel service vendor for a total number of seats at a bulk discount rate, defining a package which includes the right to obtain a prescribed number of seats from the total number of seats in each of several intervals of time, computing a net present value (NPV) of the package, defining an offering amount for the package at the NPV plus a transaction margin, subscribing a customer to the offering, investing any collected amounts for the offering to generate a ticket payment for a claimed seat, and paying the travel service vendor for a seat claimed by the customer using the ticket payment.

These and other aspects, features and advantages of the present invention can be more fully understood from the accompanying drawings and description of certain embodiments thereof.

### DESCRIPTION OF THE DRAWINGS

Non-limiting and non-exhaustive embodiments of the present invention are described with reference to the accompanying drawings.

FIG. 1 illustrates arrangement in which the present invention operates;

FIG. 2 illustrates one example of a process flow for managing and distributing the right to obtain seats for travel on a travel service;

FIG. 3 illustrates one example of a process flow for subscribing a customer to a subscription offering of airline travel services;

FIG. 4 illustrates one example of a process flow for enabling a customer to claim a prescribed seat; and

FIG. 5 shows one configuration of a net present value model for maintaining a transaction margin on the marketing of periodic travel services, in accordance with the present invention.

### DETAILED DESCRIPTION OF CERTAIN EMBODIMENTS

The present invention is described more fully hereinafter with reference to a specific exemplary embodiment. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or automated systems or devices. Accordingly, the present invention may take the form of an entirely hardware embodiment, an entirely software embodiment or an embodiment combining software and hardware portions. The following detailed description is, therefore, not to be taken in a limiting sense.

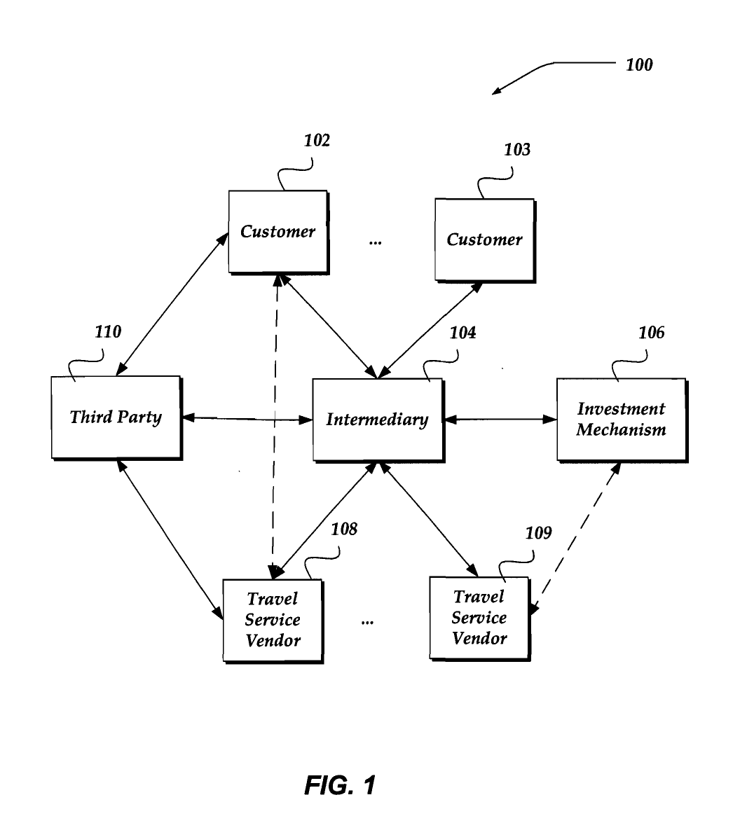

FIG. 1 illustrates one arrangement in which the present invention can operate. As shown, a system 100 of FIG. 1 operates with customer computers 102-103, intermediary computer 104, investment mechanism 106, travel service vendor computers 108-109, and third-party computer 110. Although illustrated schematically as single computers, intermediary 104, investment mechanism 106, and third-party 110 may be several separate computers or network compatible components. For example, system 100 may include several third-parties, without departing from the spirit of the present invention.

The components of system 100 can include any mechanism for communicating data over a network, including computers, mobile devices, embedded devices or the like. The components provide user interfaces to a user to control the device, or can operate automatically or semi-automatically under program control. The components of system 100 communicate with each other over a network, such as a LAN, WAN, the Internet or the like. Alternatively, one or more components communicate with each other through a direct connection. In some embodiments, some components, such as intermediary 104 and investment mechanism 106 can be hosted on the same device and communicate through a data bus, memory, or the like.

As shown, intermediary 104 is in communication with customers 102-103, third-party 110, and travel service vendors 108-109. In a particular embodiment, investment mechanism 106 is in communication with at least one of travel service vendors 108-109. In a particular embodiment, at least one of customers 102-103 is in communication with at least one of travel service vendors 108-109. Third-party 110 is in communication with travel service vendors 108-109, customers 102-103 and intermediary 104.

System 100 is arranged to enable travel service vendors 108-109 to guarantee the sale of seats within a pre-determined period of time given a volatile market. Travel service vendors 108-109 can minimize its risk in the market through contractual arrangements concerning the sale of seats. Travel service vendors 108-109 can be any travel services, including airlines (e.g. large scale spoke and hub carriers), ship lines, bus lines, train lines, or the like. Travel service vendors 108-109 can also comprise a mechanism, such as a network device, controlled by such travel services. As used herein, the term “seat” refers to any physical seat, spot, location, or the like, on a transportation mechanism, such as a plane, train, ship, or the like. In a particular embodiment, travel service vendors 108-109 may provide tickets at deep discounts to and from particular geographical zones, or the like.

System 100 is arranged to enable third-party 110 to add value to a product and/or service that the third-party 110 may offer by including a discounted travel package from one of the travel service vendors 108-109. For example, third-party 110 can offer a travel package from a start location to a location managed by third-party 110. Third-party 110 may include owners/managers of time-shares in real estates, an educational institution, a location of a sporting event, or other frequently occurring event or the like. Third-party 110 may also include travel agents, time-share developers, time-share management, time-share trading pools (e.g. RCI), or the like. In a particular embodiment, a time-share seller/reseller may offer a travel package that guarantees a seat on a flight to a particular time-share location in the period when the customer has a right to occupy that time-share location. Similarly, a college can offer a travel package that guarantees a seat on a flight to the college at the beginning and/or end of certain school holidays, or the like. In general, third-party 110 can offer a travel package for any time-frame associated with a contractual right to occupy a location. Thus, third-party 110 may increase the value to its customers of its products and/or services by offering the travel package. In a variation of the foregoing, the intermediary 104 and the third-party 110 can be the same entity.

System 100 is also arranged to enable customers 102-103 wishing to travel to a destination over a period of time to lock in a price rate/discount for a travel package by pre-purchasing the package, as described in more detail below.

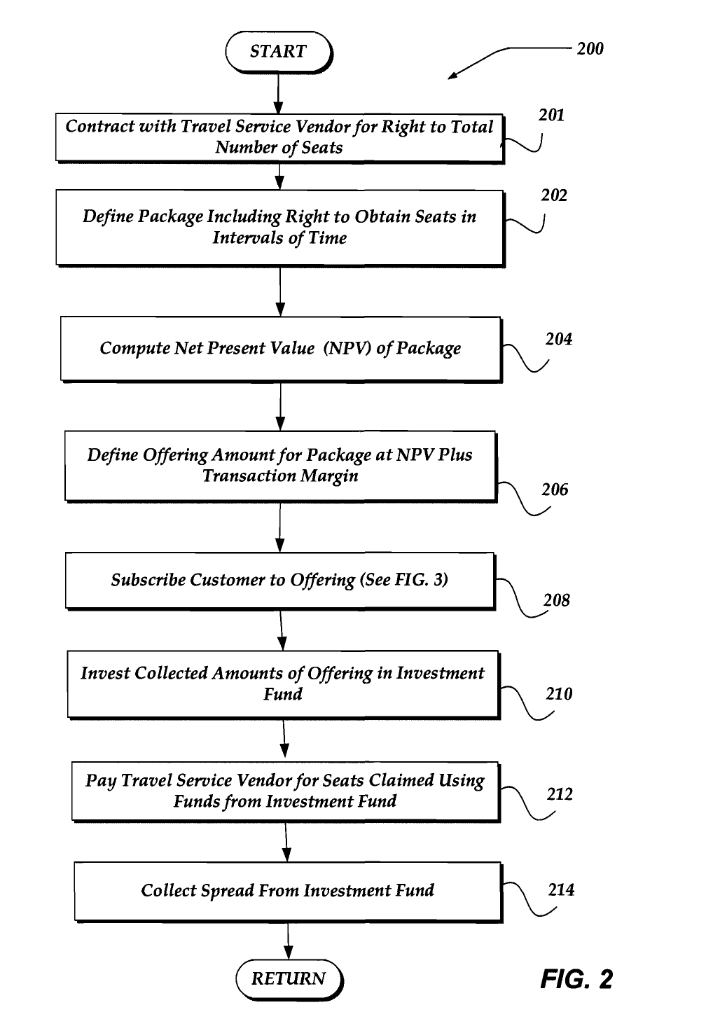

Intermediary 104 can be arranged to facilitate communication, travel package offerings, and/or management between the various components of system 100. In a particular embodiment, intermediary 104 makes use of an investment mechanism 106 to fund seats, and the like. Investment mechanism 106 can comprise an interest bearing account managed automatically and/or by managers. In a particular embodiment, investment mechanism 106 is managed by a syndicate of blue chip money managers (e.g., Merrill Lynch, Goldman Sachs, et al.). In a given embodiment, the various components of system 100 can be enabled to perform the processes 200-400 of FIGS. 2-4, described next, in order to facilitate such communication and management.

FIGS. 2-4 show exemplary processes in accordance with certain aspects of the present invention. Processes 200-400 of FIGS. 2-4 can be performed by the components of system 100 of FIG. 1, but is not limited to this embodiment. In the drawings, like reference numerals refer to like parts throughout the various figures unless otherwise specified. In general processes 200-400 can be performed by any entities capable of offering travel services, performing computation, investing funds, purchasing travel services, and the like. In a particular embodiment, processes 200-400 are performed by persons and/or mechanisms communicating over any medium (e.g. web, email, phone, fax, voice).

As shown, FIG. 2 illustrates one example of a process flow for managing and distributing the right to obtain seats for travel on a travel service. Process 200 begins at block 201, where a right to a total number of seats is contracted with a travel service vendor. Preferably, it is the intermediary 104 who enters into the contract with the travel service vendor. This contracting can involve further steps such as negotiating a fixed discount to a travel service vendor's lowest wholesale rate or the contract can be based on a formula for projecting a cost increase and/or volume increase for the travel service vendor's market. In a particular embodiment, intermediary 104 of FIG. 1 obtains the seats from travel service vendors 108-109 in accordance with the contract.

Processing next flows to block 202, where a package, which includes the right to obtain a prescribed number of seats in each of several intervals of time, is defined. In a particular embodiment, the prescribed number of seats are selected from the contracted total number of seats. Each of seats can be used within a particular period of time. The intervals of time can be periodic, equally spaced apart, or the like. The intervals of time preferably correspond to the time a customer may have a right to occupy a time-share, or the like. In a particular embodiment, the right to obtain the prescribed number of seats can be associated with any one or all of the following: a start location, a destination location, a geographical zone, a number of customers utilizing the seats, a season, a time of year, and a time-frame associated with a contractual right to occupy a location.

In a particular embodiment, intermediary 104 of FIG. 1 defines a package including a right to obtain a travel service within an interval of time. Such package can be pre-defined, or defined by user input. In a particular embodiment, intermediary 104 of FIG. 1 receives the definition of the package from one of customers 102-103 and defines the package accordingly. In a particular embodiment, intermediary 104 receives the package information from at least one of travel service vendors 108-109. In a particular embodiment, travel service vendors 108-109 provide the package at a guaranteed discount, at an amount below the current market rate for a seat, or the like. In a particular embodiment, customers 102-103 forward package information from intermediary 104. Customers 102-103 can send information for defining the package directly to intermediary 104 or through at least one of travel service vendors 108-109.

As one non-limiting example, the package can be a set of four economy class airline tickets usable in the third week of August of each of ten successive years from La Guardia Airport, New York, to Cancun Airport, Mexico.

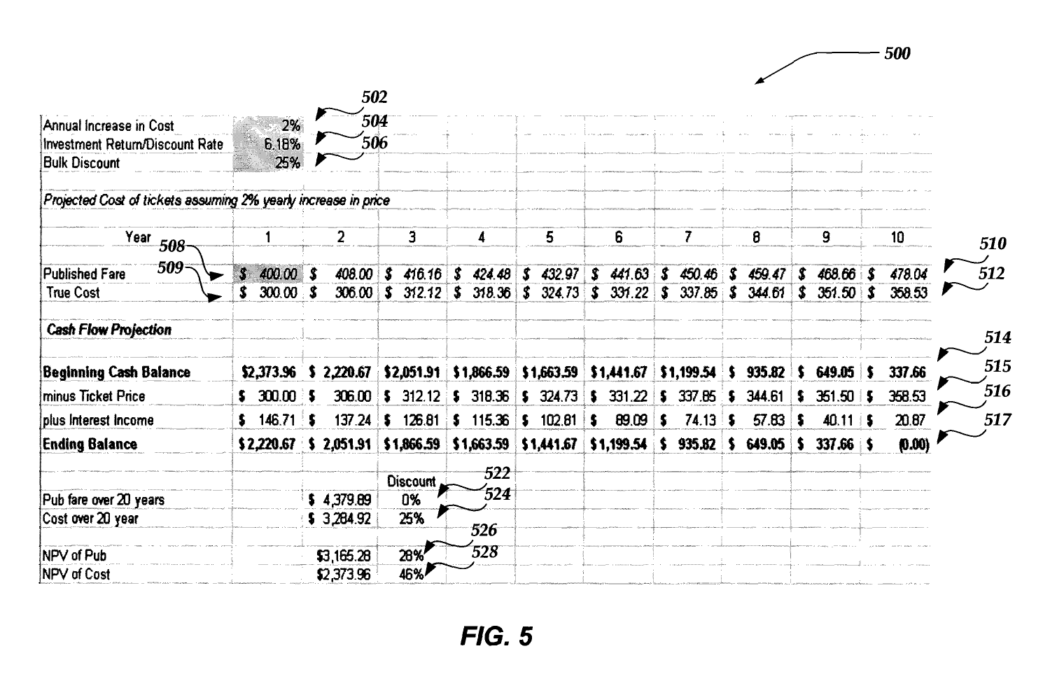

Next, processing continues at block 204, where a net present value (NPV) of the package is computed. The NPV of the package can be computed as a function of the cost of the seat realized at a particular time, the duration between the particular time and the present time, and a discount rate. The NPV for the package includes at least the sum of the NPV for each of the seats. In a particular embodiment, intermediary 104 of FIG. 1 computes the NPV for the package. In a particular embodiment, the computation of the NPV corresponds to the computation described in conjunction with model 500 of FIG. 5.

Next processing continues at block 206, where an offering amount for the package is defined as the NPV of the package plus a transaction margin. The transaction margin can be pre-defined, defined by user input, based on a schedule, rate table, or can be a function of a trend in a cost increase of seats over time or the like. In a particular embodiment, intermediary 104 of FIG. 1 defines the offering amount for the package.

Next processing continues at block 208, where a customer is subscribed to the offering. The offering preferably comprises the package. The offering can also include other packages, benefits, coupons, promotions, products, services, and the like. In a particular embodiment, intermediary 104 of FIG. 1 subscribes at least one of customers 102-103 to the offering at at least an amount of the offering. A customer is subscribed to an offering when the customer agrees to pay, or more preferably after the customer has paid for the benefits or rights accorded under the offering by providing a payment into a designated account.

Next processing continues to block 210, where any collected offering amounts is held in an investment account. The collected offering amounts can be partially or wholly provided to the investment account. In a particular embodiment, the investment account preserves a managed margin, which is a difference between the invested assets gain and the increase in ticket prices annually. In this embodiment, the return on investment in the account is preferably based on a prediction of the ticket payment price for a claimed seat based on an annual increase in cost. Thus, the investment account preferably takes into account any increase in ticket prices. In a particular embodiment, intermediary 104 of FIG. 1 provides such amounts via an electronic fund transfer, or the like, to investment mechanism 106.

Next processing continues at block 212, where the travel service (e.g. an airline) is paid for any seats that are actually claimed by the customer. Payments can comprise the use of funds from at least the investment account, so that the customer enjoys the benefits of the subscription price without experiencing any price fluctuations for the seat(s). In a particular embodiment, intermediary 104 of FIG. 1 is paid an administrative margin for processing the payment for a seat claimed by a customer. In a particular embodiment, intermediary 104 receives and/or retrieves at least a portion of the seat price from the investment mechanism 106 and pays travel service vendors 108-109, e.g., by an electronic fund transfer or the like. In another embodiment, investment mechanism 106 pays at least a portion of the seat price directly to travel service vendors 108-109 under program control.

Next processing continues at block 214, where a spread from the investment account is collected. As used herein, “spread” refers to an excess in the monies managed by an investment account over that which is necessary to pay for prescribed tickets, e.g., those still claimable by subscribed customers. In a particular embodiment, the spread is collected annually.

In a particular embodiment (not shown), process 200 further includes periodically charging a customer an activity margin for a right to claim the prescribed number of seats in his or her subscribed package. In a particular embodiment, intermediary 104 of FIG. 1 periodically (e.g., annually, semi-annually) charges customers 102-103 the activity margin. The activity margin can be fixed, based on the amount of activity of the customer (e.g. number of seats claimed), or variable in another predetermined way.

In a particular embodiment (not shown), process 200 further includes obtaining additional rights to further seats for providing to customers to satisfy demand, in the event that a demand for seats exceeds the total number of seats available under the contract (block 201) with a particular transportation provider/travel service vendor. In a particular embodiment, intermediary 104 of FIG. 1 receives more requests for packages than are available under a given contract. Thus, intermediary 104 can negotiate with the same or further travel service vendors 108-109 for additional seats and obtain the seats to satisfy demand.

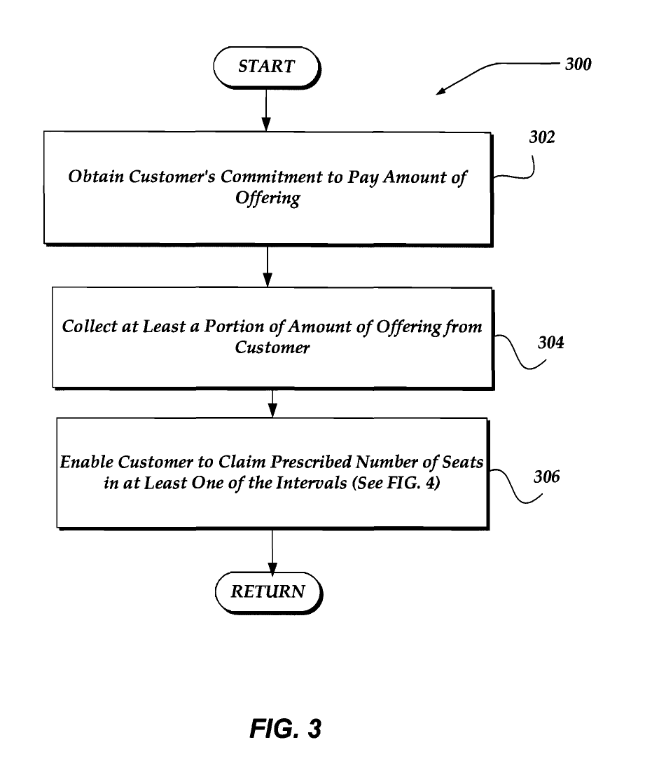

FIG. 3 illustrates an exemplary process flow for subscribing a customer to an offering. Process 300 begins at block 302, where the customer's commitment to pay the offering amount is obtained. In a particular embodiment, intermediary 104 of FIG. 1 subscribes at least one of customers 102-103 by obtaining a commitment from customers 102-103 to pay the amount of the offering. In a particular embodiment, intermediary 104 communicates the offering to customers 102-103 via an e-commerce mechanism, e-mail, voice mail, postal mail, or the like. Intermediary 104 receives from customers an indication of the commitment, over a network, or the like. In a particular embodiment, customers 102-103 select and/or specify an offering on a web interface, through drop-down menus, or the like. Customers 102-103 can send the selected and/or specified information to intermediary 104 for further processing.

Next processing continues at block 304, where at least a portion of the offering amount is collected from the customer. In a particular embodiment, intermediary 104 of FIG. 1 collects at least a portion of the amount of the offering from customers 102-103. In a particular embodiment, the portion includes at least the transaction margin. In a particular embodiment, customers 102-103 define that portion. In a particular embodiment, intermediary 104 receives an electronic fund as payment. For example, intermediary 104 can receive an authorization to perform an automated electronic fund transfer on a bank account of a user associated with customers 102 103 or to charge a credit card authorization in an amount. In a particular embodiment, intermediary 104 collects the portion over time, e.g., on a schedule, or the like.

Next processing continues at block 306, where the customer can claim up to the prescribed number of seats in his or her package in at least one of the several intervals. In a particular embodiment, intermediary 104 of FIG. 1 enables at least one of customers 102-103 to claim the prescribed number of seats in at least one of the intervals. In a particular embodiment, the seat can be claimed within a time period defined in the package.

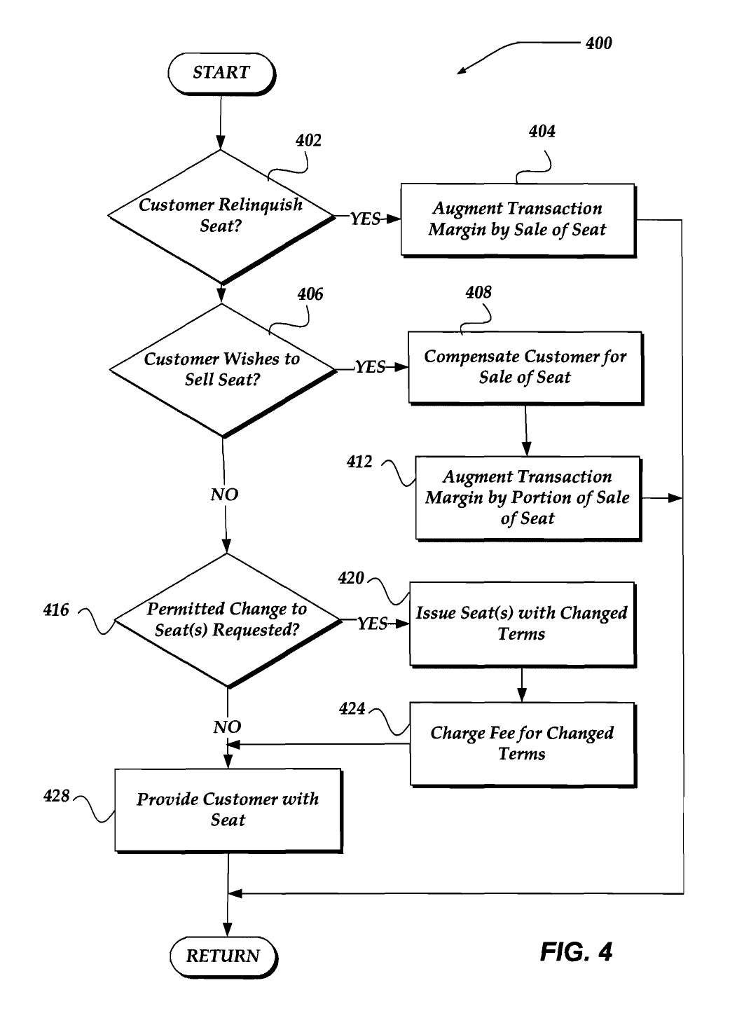

FIG. 4 illustrates an exemplary process flow for enabling a customer to claim a prescribed seat. Process 400 begins at decision block 402, where it is determined whether a customer has indicated a desire to relinquish the prescribed seat. In a particular embodiment, intermediary 104 receives from one of customers 102-103 an indication that a seat is to be relinquished and processing continues at block 404. In a particular embodiment, customers 102-103 send the indication to intermediary 104 through a form on a web interface, over e-mail, SMS or the like. The relinquishment indication can be received from customers 102-103 over a network, or the like. In a particular embodiment, the relinquishment indication is parsed and/or otherwise compared to threshold values, fields in a database, or the like, to confirm that customers 102-103 are allowed to relinquish the seat. In another embodiment, the relinquishment indication may be automatically generated by intermediary 104 in the event that no claim for a seat has been made or detected by a programmed machine (e.g., the computer of intermediary 104) monitoring such events. In this event, intermediary 104 can mark a field in a database and/or send a message to customers 102-103 indicating that the seat has been relinquished.

It should be appreciated that an unclaimed seat in a package is a “relinquished” seat, and the indication of relinquishment may be a “non” event such as a failure to claim the seat(s) to which a subscriber is otherwise entitled to based on the package to which he or she is subscribed. The relinquishment can occur if the seat has not been claimed within a time window, by a particular time, or the like. In that event, the intermediary 104 can claim the seat for its own purposes, including resale. This is because the intermediary 104, having negotiated with one or more travel service providers for a certain number of seats, is obliged to pay the travel service provider for the seats that have been reserved under contract, without regard to who uses those seats. The same is true in a variation of the foregoing in which the third party 110 was the entity that entered into the contract with one or more of the travel service providers.

At block 404, the transaction margin associated with the package is augmented by the sale of the seat to a third party (e.g., an online travel services portal or website). In a particular embodiment, intermediary 104 makes the sale to another customer, user, ticket pool, or the like. Intermediary 104 can send an email, or other type of network message, to a server associated with the third party, other customer, ticket pool, or the like. In a particular embodiment, the server can credit an account associated with intermediary 104 as soon as the network message is received, or can otherwise pay intermediary 104 upon the sale of the seat. The transaction margin can be increased by at least a portion of funds received from the sale. In a particular embodiment, the portion is the profit from the resale of the seat.

Referring again to the non-limiting example above, if the customer having a package including a set of four economy class airline tickets usable in the third week of August of each of ten successive years has not made a claim for the tickets in a given year by a prescribed date (which may be before or after the third week of August, depending on the terms of the contract with the travel service provider), the intermediary 104 can take dominion over that set of seats and sell or use them as it so desires, with the benefits of such sale or use inuring to the intermediary. On the other hand, the customer has paid an amount for the right to those tickets, but having relinquished that right in the given year in this example, has no claim against the intermediary for a refund of any amount.

If the test at decision block 402 determines that the customer does not wish to relinquish the seat, then processing continues at decision block 406. At decision block 406, it is determined whether the customer wishes to sell the seat or change its terms for a fee (e.g., to travel a different week). In a particular embodiment, customers 102-103 select, on a form on a web interface, an option to sell the seat(s). This selection preferably is made within a time window (e.g., a particular time window starting before the time the seat must be claimed). If the selection is made within the time window, then the web interface may send an indication to sell the seat to intermediary 104. Otherwise, customers 102-103 receives an error message, or the like. In a particular embodiment, intermediary 104 may receive the indication to sell the seat as a network message, packet, or the like. In a particular embodiment, the indication to sell is parsed by intermediary 104 and/or otherwise compared to threshold values, fields in a database, or the like, to confirm that customers 102-103 are allowed to sell the seat. In a particular embodiment, if intermediary 104 of FIG. 1 receives from one of customers 102-104 the indication that the seat is to be sold, then processing continues at block 408. Otherwise, processing continues at decision block 416. In an alternate embodiment (not shown), if customers 102-103 are not allowed to sell the seat, the seat is instead indicated as relinquished, and processing steps to block 404.

At block 408, the customer is compensated for the sale of the seat because the customer is, effectively, consigning his or her right to the seat(s) in the package to intermediary 104. In contrast to a relinquishment of the seat(s), here the system 100 has detected or been informed by an affirmative act of the customer, such as an email notification or another type of submission received at a server associated with the intermediary computer. In a particular embodiment, intermediary 104 compensates the customer for the sale of the seat. In a particular embodiment, the seat is sold to another customer, user, ticket pool, or the like. The customer can be compensated by receiving at least a portion of funds from the sale of the seat through an electronic fund transfer, or the like. From block 408, processing next continues to block 412, where at least a portion of the sale of the seat augments the transaction margin realized by the intermediary 104. For example, the portion of the sale can be used by intermediary 104 to augment the transaction margin associated with that customer's package.

At block 416, a test is made to determine whether the customer has indicated a desire to change the terms of the seat(s) to be claimed for a present interval of the customer's subscribed-to package, which change is permitted by the system. The customer may be restricted from making any changes at all; but in the flow diagram of FIG. 4 an optional process flow permits the customer to make such changes in certain circumstances. For example, the system permits such changes to be made and seats (e.g., air travel tickets) to be issued with terms that deviate from those defined in the subscription when the request is made a prescribed number of days before the defined window of travel, or when the change is from one airport to another airport within the same commercial zone, or to upgrade from one class of travel to another (e.g., economy to first class), or a combination of the foregoing or other changes. If the changes are permitted, then at block 420, a set of seats is issued with the changed terms. The customer is preferably charged a fee for any permitted deviation from the defined subscription package, as indicated at block 424. The customer is then provided with the seat(s) at step 428.

At block 428, it has been determined that a customer does not wish to relinquish or sell the seat. Thus, the customer is provided the seat, either as per the subscription or any permitted deviations as described above. In a particular embodiment, intermediary 104 of FIG. 1 and/or one of travel services 108-109 provides an e-ticket or the like to customers 102-103. Alternatively, the ticket is provided via postal mail, redemption at a ticket counter or the like. It is at this step that the option to claim seats is converted from a bearer-right to a customer-specific right.

It will be understood that the blocks of the above flowchart illustrations can be performed in different orders and some blocks may be omitted, without departing from the spirit of the invention.

It will also be understood that each block of the flowchart illustrations, and combinations of blocks in the flowchart illustrations, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps may also be performed across more than one processor, such as might arise in a multi-processor computer system.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

Further, it should be understood that aspects of any particular embodiment or arrangement of a specific component or step can be combined with features and aspects of other embodiments and arrangements of components and steps in practicing the present invention.

Illustrative Net Present Value Model

FIG. 5 shows one embodiment of a net present value model for maintaining a transaction margin on the trading of periodic travel services. Model 500 shows a Net Present Value (NPV) analysis of a cost associated with ten seats to be provided to a customer each year for ten years. Although ten years of data are shown, this model can be used for any number of years. The NPV can be calculated by the following formula, where t is the amount of time (usually in years) that cash has been invested in a project, N the total length of the project, i the discount rate, and C the cash flow at that point in time.

$$NPV = {\sum }_{t = 0}^{N} \frac{{C}_{t}}{{( 1 + i )}^{t}}$$

One of ordinary skill in the art will appreciate that the above formula can be modified to account for uneven cash flows, the use of a yield curve to give different discount rates for the various time points on the calculation, and the like. Although illustrated as using a NPV model, almost any discounted cash flow analysis can be used to ensure that a positive overall transaction margin, managed margins, and/or a spread are realized at the end of a specified period.

Model 500 also assumes an annual increase in fares 502 of 2%, a discount rate 504 of 6.18%, a bulk discount rate 506 of 25%, and an initial published fare for a seat 508 of $400. It should be noted that these value are inputs into the model, and the model can use any values as deemed appropriate by the intermediary 104 or third-party 110—whoever is offering the subscriptions. Model 500 also includes an initial true cost of a seat 509 which is the cost to purchase a seat that is negotiated by an intermediary with a travel service vendor. As shown, initial true cost of a seat 509 is discounted from the initial published fare for a seat 508 by the bulk discount rate 506. Furthermore, model 500 is shown as applied to one initial published fare for a seat 508. However several initial published fares, with different initial inputs (e.g., discount rates, annual increase in cost), can be also computed without departing from the spirit of the invention.

Row 510 shows each year's published cost starting from the initial published fare for a seat 508, using the annual increase in fares 502. Row 512 shows each year's true cost for a seat starting from the initial true cost of a seat 509, using the annual increase in fares 502. The amounts of row 512 represent the projected cost, negotiated with a travel server provider, for the plurality of seats over the specified interval of time (here, ten years).

The sum of published fare 522 is the sum of row 510. The sum of cost of fare 524 is the sum of row 512. As shown, savings from the sum of cost of fare 524 over the discount of the published fare 522 is 25%. NPV of published fare 526 is the net present value calculation of the cash flows from row 510 given the discount rate 504 over the ten-year interval of time. As shown, savings from the NPV of published fare 526 over the discount of the published fare 522 is 28%. NPV of cost of fare 526 is the net present value calculation of the cash flows from row 512 given the discount rate 504 over the ten-year interval of time. As shown, savings from the NPV of cost of fare 526 over the discount of the published fare 522 is 46%. Thus, an offering amount for a package of seats at this amount may be perceived by a customer as a 46% savings over the amount that the customer must pay for a package of seats on the open market (e.g., the published fare). The offering amount for the package can be increased up to the sum of published fare 522 while still ensuring a perceived value to the customer, all while providing the intermediary/third-party with an economic incentive to manage the subscription.

Rows 514-520 show an example of a situation in which a customer is offered a package represented by row 512, at the NPV of cost of fare 526. If the NPV of cost of fare 526 is invested in an investment mechanism which has a yield of the discount rate 504, then the investment mechanism yields an amount every year for payment of the seat to be provided. As shown, row 514 shows available cash for each year. Row 515 shows the projected cost of a seat for each year. Row 516 shows the interest earned by the amount from row 514 for each year. Row 517 shows the available cash after paying the projected cost of the seat and earning the interest (e.g. the amount from row 514, minus the amount from row 515, plus the amount from row 517). As shown, the ending balance from row 517 at the end of ten years is $0.

It will be appreciated that the spread is $0 in this case because the package is offered at the NPV of cost of fare 526. However, increasing the initial cost of the package offered to a customer by a transaction margin will yield a higher spread (e.g. by the NPV of the transaction margin). Alternatively, the transaction margin can be realized as a profit from a payment made by the customer without adversely affecting the ability to pay for a seat(s). Also, it will be appreciated that while model 500 assumes that the interest rate yielded by the investment mechanism is the discount rate 504, a well-managed investment mechanism can be expected to yield a significantly higher rate of return. Thus, the spread will also be increased accordingly. In a particular embodiment, the investment mechanism also yields a rate of return sufficient to preserve a managed margin, in order to account for changes to seat prices over time, or the like.

Since many embodiments of the invention can be made without departing from the spirit and scope of the invention, the invention is to be defined by the claims hereinafter appended.

What is claimed is:

1. A method for managing and distributing the right to obtain seats for travel on an airline, comprising the steps, in the order presented, of:
(a) defining a package which includes the right to obtain a prescribed number of seats in each of several intervals of time;
(b) computing a net present value of the package;
(c) defining an offering amount for the package at the net present value plus a transaction margin;
(d) subscribing a customer to the offering by:
(1) obtaining the customer's commitment to pay the offering amount;
(2) collecting at least a portion of the offering amount from the customer, and
(3) enabling the customer to claim the prescribed number of seats in at least one of the several intervals;
(e) investing any collected offering amounts in an investment account; and
(f) paying the airline for any seats claimed by the customer using funds from at least the investment account.

2. The method of claim 1, including the additional step of augmenting the transaction margin collected from a particular customer by selling one or more of any unclaimed seats of that customer.

3. The method of claim 1, including the additional steps of obtaining an instruction from a particular customer to sell the one or more unclaimed seats and compensating the customer for that sale.

4. The method of claim 3, including the additional step of augmenting the transaction margin associated with that particular customer using the proceeds of the sale.

5. The method of claim 1, further comprising contracting for the package with the airline at a price for each of the prescribed number of seats

6. The method of claim 1, further comprising collecting a spread from the investment account.

7. A method for managing and distributing the right to obtain seats from a travel service vendor, comprising:
(a) contracting with the travel service vendor for a total number of seats at a bulk discount rate;
(b) defining a package which includes the right to obtain a prescribed number of seats from the total number of seats in each of several intervals of time;
(c) computing a net present value of the package;
(d) defining an offering amount for the package at the net present value plus a transaction margin;
(e) subscribing a customer to the offering;
(f) investing any collected amounts for the offering to generate a ticket payment for a claimed seat; and
(g) paying the travel service vendor for a seat claimed by the customer using the ticket payment.

8. The method of claim 7, wherein investing the any collected amounts comprises investing to earn a rate of return at at least a discount rate for the net present value of the package.

9. The method of claim 7, further comprising predicting the ticket payment for a claimed seat based on an annual increase in cost.

10. The method of claim 7, further comprising obtaining additional rights to another prescribed number of seats for providing to customers, if a demand for seats exceeds the total number of seats.

11. The method of claim 7, wherein the right to obtain the prescribed number of seats is associated with a start location, a destination location, a geographical zone, a number of customers utilizing the seats, a season, a time of year, or a time-frame associated with a contractual right to occupy a location.

12. The method of claim 7, further comprising periodically charging a customer an activity margin for a right to claim the prescribed number of seats.
